(19) United States
(12) Patent Application Publication
(10) Pub. No.: US 2005/0035705 A1
(43) Pub. Date: Feb. 17, 2005

(54) Illumination system

(76) Inventor: William S. Haas, Bartonville, IL (US)

Correspondence Address: BARNES & THORNBURG, P.O. BOX 2786, CHICAGO, IL, 60690-2786, US

(21) Appl. No.: 10/911,002

(22) Filed: Aug. 4, 2004

Related U.S. Application Data
(60) Provisional application No. 60/497,417, filed on Aug. 11, 2003.

(51) Int. Cl. H05B 33/00; H05B 33/14

(52) U.S. Cl. 313/503; 313/506; 313/509

(57) ABSTRACT

An illumination device enables the controlled configuration of the illumination or heating elements in an apparatus for use in numerous applications. The illumination device may be used to create lighted images of virtually any design, or message in applications such as, for example, greeting cards and advertising light boxes.

This application claims priority to provisional patent application Ser. No. 60/497,417 filed Aug. 11, 2003, which is incorporated herein by reference.

### BACKGROUND

The present disclosure relates to an illumination device and system.

Many variations of lighting systems are used to allow viewing of, for example, creative artwork or other indicia in the marketing and advertising industry. The systems may be incorporated in, for example, light boxes, greeting cards or other marketing or advertising materials. Such systems are not limited to the marketing and advertising industry.

### SUMMARY

The present disclosure comprises one or more of the following features or combinations thereof disclosed herein or in the Detailed Description below.

The present disclosure relates to an illumination device comprising a substrate; a first layer comprising conductive ink; the first layer disposed on the substrate; a second layer comprising luminescent ink, the second layer disposed on the first layer; a third layer comprising dielectric coating, the third layer disposed on the second layer; a fourth layer comprising conductive ink, the fourth layer disposed atop the third layer; and an electric power source electrically connected to at least one of the first and fourth layers for illuminating the second layer. The device may include other features such as, for example, a controller for controlling the amount of electricity applied thereto. Additionally, the device may be included with a holder for holding the device.

Additional features of the present disclosure will become apparent to those skilled in the art upon consideration of the following detailed description of illustrative embodiments of the disclosure.

### BRIEF DESCRIPTION OF THE DRAWINGS

The Detailed Description particularly refers to the accompanying figures in which:

FIG. 1 is a diagrammatic perspective view of layers forming an illumination device in accordance with an embodiment of the present disclosure;

FIG. 2 is a cross-sectional diagrammatic view of the illumination device, also illustrating the controller of the device;

FIG. 3 is a cross-sectional view of a light box incorporating the illumination device of FIGS. 1 and 2;

FIG. 4 is a perspective view of a greeting card incorporating the illumination device of FIGS. 1 and 2;

FIG. 5 is a cross-sectional view of the greeting card of FIG. 4.

### DETAILED DESCRIPTION

While the present disclosure may be susceptible to embodiment in different forms, there is shown in the drawings, and herein will be described in detail, embodiments with the understanding that the present description is to be considered an exemplification of the principles of the disclosure and is not intended to limit the disclosure to the details of construction and the number and arrangements of components set forth in the following description or illustrated in the drawings.

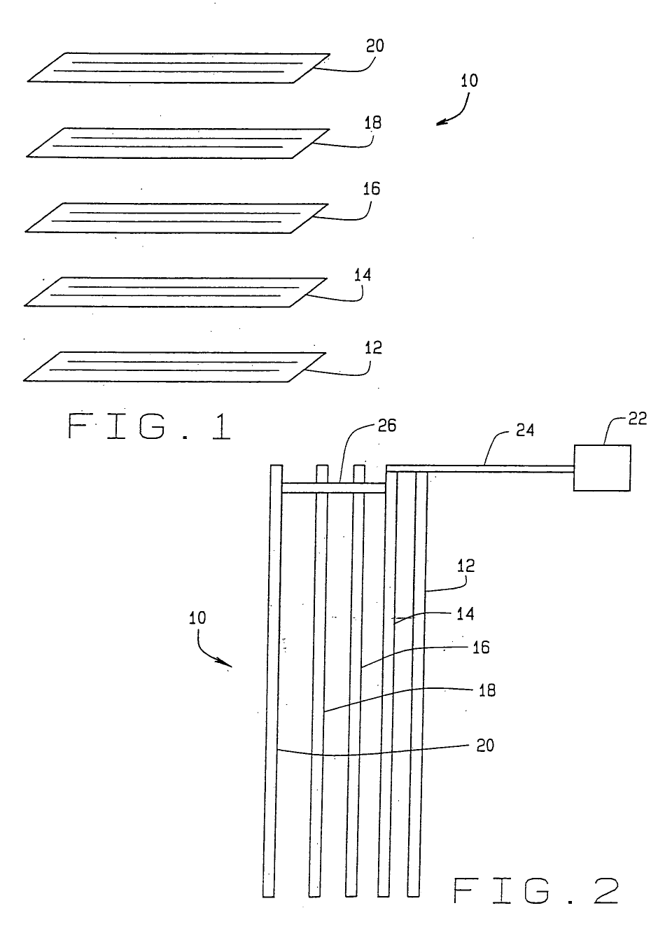

FIGS. 1-5 show an illumination device 10 in accordance with an illustrated embodiment of the present disclosure. The device 10 includes a substrate layer 12, a first conductive material layer 14, a luminescent ink layer 16, a dielectric layer 18 and a second conductive material layer 20. The substrate layer 12 may be composed of UV based transparent conductive ink or any other suitable materials such as, for example, any suitable transparent conductive solvent based or UV (ultraviolet light) based conductive fluids or inks. The conductive material layers 14, 20 may be comprised of UV based conductive silver ink or any other suitable materials such as, for example, any other suitable solvent based or UV based dielectric fluids or inks. The dielectric layer 18 may be composed of solvent based or UV based dielectric fluids or inks or any other suitable materials.

The inks used to form the luminescent ink layer 16 may be both conductive and electro-luminescent and thus may emit light when subjected to electrical current. Such inks include, for example, solvent based or UV activated Phosphor fluids or inks. Under certain conditions these fluids may become a source of light when subjected to an alternating electrical field. The solvent-based fluids are cured by subjecting them to a heat source (e.g., a heating oven or a heating lamp). UV activated fluid may be cured by merely subjecting them to a UV light source, which provides a more rapid cure time and a more environmentally acceptable alternative to solvent based fluids.

The device 10 may be formed, for example, when the first conductive material layer 14 is applied to the printed substrate layer 12, the luminescent ink layer 16 is applied to the first conductive material layer 14, the dielectric layer 18 is applied to the luminescent ink layer 16, and the second conductive material layer 20 is applied to the dielectric layer 18.

The substrate 12 may be treated and may be comprised of many print-type materials such as, for example, a print treated film or other such carrier. The layers 14 through 20 are each applied sequentially atop the substrate 12. All of the layers 14 through 20 are applied as a fluid in a printing process, and then cured to a solid form. Of course, the layers may be cured in differing sequences depending on the materials used, the curing temperatures and cycle times, and the potential need to apply a fluid or uncured layer upon a cured or partially cured layer. As part of this process, the luminescent ink 16 may be applied to the first conductive material layer 14 in a pattern containing a desired image or message. Hence, the film 10 can be produced in different configurations and with virtually any printable image or message imbedded in the film.

An alternating current power source 22 (FIG. 2) may be attached directly to both the substrate 12 and the first conductive material layer 14 with a first power line 24. A second power line 26 connects the first conductive material layer 14, the luminescent ink layer 16, the dielectric layer 18 and the second conductive material layer 20. The first and second power lines 24 and 26 do not directly contact one another.

This process may include the following steps:

1. Create a base or substrate of transparent UV conducive fluid. This replaces the conventional Indium Tin Oxide in the prior art.

2. Apply an electrical grid to the substrate using UV silver conductive fluid.

3. Apply the UV luminescent/phosphor fluid to the surface in the form of a desired design or message, using, for example, one of the printing techniques well understood in the art such as etch-back or off-set print.

4. Apply the dielectric layer to the remaining surface area.

5. Apply the UV silver fluid conductive layer to complete the circuit and enable ready connection to a source of electricity.

When electricity is applied to the film 10 through the power lines 24, 26, the current will alternately charge the first and second conductive material layers 14, 20. The dielectric layer 18 will prevent the discharge of the current. However, the current will create an alternating electromagnetic field across the luminescent ink layer 16 which will excite the ink in the layer and cause it to glow. Because it is patterned, the luminescent ink layer will selectively illuminate only the pattern formed by the ink atop the first conductive material layer 14.

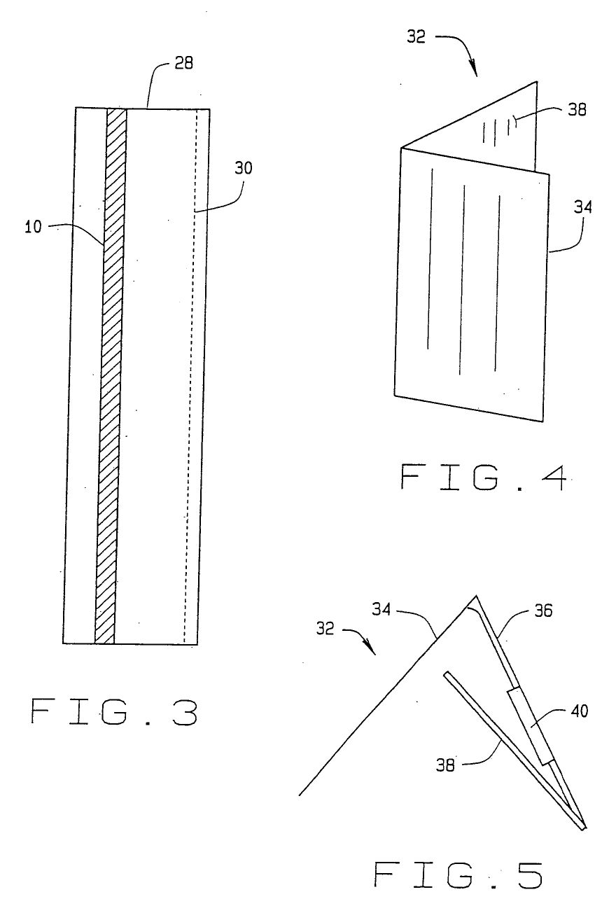

The illumination device 10 can be incorporated into any suitable holder, including, for example, a light box 28 as illustrated in FIG. 3. In such an application, the film 10 may be placed within the box 28. A message panel 30 may be placed in front of the film 10 at the front of the box 28. The panel 30 may be either translucent or transparent, and has a desired message or image on its surface. When used in this configuration, it is not necessary for the film 10 to have a design or image formed by the luminescent ink 16. Rather, when electricity is applied to the film 10, the light emanating from the film illuminates the panel 30 from behind and creates silhouette lighting of the design or image on the panel.

FIGS. 4 and 5 illustrate the illumination device 10 incorporated into a greeting card 32. In this particular configuration, the card 32 comprises a front flap 34, a rear flap 36 and a third flap 38 (FIG. 5), wherein the film 10 forms the third flap 38. The film 10 forming the third flap 38 is configured to present its illuminated message or image toward inner face of the front flap 34. For illustrative purposes, the third flap 38 is shown open and pulled away from the rear flap 36. However, the third flap 38 may be pressed flat against the inner face of the rear flap 38 so as to form an aesthetic dual-flap greeting card configuration. A power source 40, such as for example a Lithium battery, is placed on the rear flap 36 and is connected to the film 10 to power and thereby illuminate the film for the viewer. The film 10 may alternately be located on any surface of the card 32 as may be desired.

The illumination device 10 is not limited to the configuration in the illustrated embodiment. Rather, other embodiments of the present invention are considered. For example, elastic materials may be used to form the substrate layer 12 and the layers 14, 16, 18, 20, thereby enabling the manufacture of a free-standing light strip that is flexible. Additionally, the substrate 12 and the layers 14, 16, 18, 20 can be formed in virtually any printable shape and pattern, in a wide variety of sizes. Further, the substrate may have a topography other than that of a plane, such as for example a sphere, and the layers 14, 16, 18, 20, may in such circumstances be applied to the sphere (or other shape) to form a three-dimensional lighted object. By selecting different luminescent inks and the strategic use of dyes, the light emitted by the film 10 can be of differing colors.

Moreover, additional layers may be added between the layers 14, 16, 18, 20 in the illustrated embodiment, such as an additional dielectric layer and an additional luminescent ink layer between the conductive material layers. These additional layers could, for example, provide a visible distinction by providing an element of depth to the device, or enable the use different colored light emissions with different patterns.

While the concepts of the present disclosure have been illustrated and described in detail in the drawings and foregoing description, such an illustration and description is to be considered as exemplary and not restrictive in character, it being understood that only the illustrative embodiment has been shown and described and that all changes and modifications that come within the spirit of the disclosure are desired to be protected by the claims set forth below.

1. An illumination device comprising:
a substrate;
a first layer comprising conductive ink, the first layer disposed on the substrate;
a second layer comprising luminescent ink, the second layer disposed on the first layer;
a third layer comprising dielectric coating, the third layer disposed on the second layer;
a fourth layer comprising conductive ink, the fourth layer disposed atop the third layer; and
an electric power source electrically connected to at least one of the first and fourth layers for illuminating the second layer.

2. The illumination device of claim 1 further comprising a controller for controlling the amount of electricity applied to the first and fourth layers.

3. The illumination device of claim 1 wherein the conductive ink of at least one of the first and fourth layers is UV based.

4. The illumination device of claim 1 wherein the conductive ink is solvent based.

5. The illumination device of claim 1 wherein the conductive ink of at least one of the first and fourth layers comprises conductive silver ink.

6. The illumination device of claim 1 wherein the substrate comprises conductive material.

7. The illumination device of claim 1 wherein the substrate comprises transparent material.

8. The illumination device of claim 1 wherein the substrate comprises UV based material.

9. The illumination device of claim 1 wherein the substrate comprises conductive ink.

10. The illumination device of claim 1 wherein the substrate comprises UV based transparent conductive ink.

11. The illumination device of claim 1 wherein the substrate comprises solvent based ink.

12. The illumination device of claim 1 wherein the third layer comprises UV based material.

13. The illumination device of claim 1 wherein the third layer comprises dielectric ink.

14. The illumination device of claim 1 wherein the second layer comprises conductive ink.

15. The illumination device of claim 1 wherein the second layer comprises electro-luminescent ink.

16. The illumination device of claim 1 wherein the second layer comprises conductive and electro-luminescent ink.

17. The illumination device of claim 1 wherein the second layer comprises UV activated fluids.

18. The illumination device of claim 1 wherein the second layer comprises UV activated ink.

19. The illumination device of claim 1 wherein the second layer comprises solvent based ink.

20. The illumination device of claim 1 wherein the second layer forms a pattern comprising indicia.

21. The illumination device of claim 20 wherein the indicia comprises at least one of an image and a predetermined message.

22. A display device comprising an illumination device for illuminating indicia and a holder for the illumination device, the illumination device comprising:
a substrate;
a first layer comprising conductive ink, the first layer disposed on the substrate;
a second layer comprising luminescent ink forming the indicia, the second layer disposed on the first layer;
a third layer comprising dielectric coating, the third layer disposed on the second layer;
a fourth layer comprising conductive ink, the fourth layer disposed on the third layer; and
an electric power source electrically connected to the first and fourth layers for illuminating the indicia.

23. The display device of claim 22 wherein the holder comprises a card.

24. The display device of claim 22 wherein the holder comprises a box.

25. The display device of claim 22 wherein the holder comprises a sign.

26. The display device of claim 22 wherein the conductive ink of at least one of the first and fourth layers comprises UV based conductive silver ink.

27. The display device of claim 22 wherein the substrate comprises UV based transparent conductive material.

28. The display device of claim 22 wherein the second layer comprises conductive and electro-luminescent ink.

29. The display device of claim 22 wherein the second layer comprises UV activated material.

30. The display device of claim 22 wherein the second layer comprises the indicia.

31. The display device of claim 22 wherein the third layer comprises UV based dielectric ink.

32. The display device of claim 22 wherein the indicia is at least one of a predetermined image or a predetermined message.
